(19) United States
(12) Patent Application Publication
(10) Pub. No.: US 2005/0165568 A1
(43) Pub. Date: Jul. 28, 2005

(54) Alias detection when displaying FFTS

(76) Inventors: Steven K. Sullivan, Beaverton, OR (US); Linley F. Gumm, Beaverton, OR (US)

Correspondence Address: TEKTRONIX, INC.;Francis I. Gray, M/S 50-LAW, P. O. Box 500, Beaverton, OR, 97077-0001, US

(21) Appl. No.: 10/767,391

(22) Filed: Jan. 28, 2004

(51) Int. Cl. G06F 15/00

(52) U.S. Cl. 702/66

(57) ABSTRACT

For alias detection in the frequency domain a method is provided of acquiring a signal under test (SUT) at each of a first sample rate and a second sample rate to provide thereby respective first and second streams of samples, processing the first and second streams of samples according to a first function to determine thereby respective spectral energy distributions, and comparing the spectral energy distributions to determine thereby a spectral region including spectral energy common to each of the spectral energy distributions.

### BACKGROUND OF THE INVENTION

The invention relates generally to waveform analysis and, more particularly, to methods for alias detection when displaying fast Fourier transforms (FFTs).

Prior art attempts at detecting and possibly removing aliased information have been less than desirable. Analog oscilloscopes have traditionally been designed to display voltage on the vertical axis and time on the horizontal axis. With the advent of digital oscilloscopes (DSOs) it was discovered that applying certain mathematical techniques to acquired data could allow for spectrum data to be displayed, with power along the vertical axis and frequency along the horizontal axis.

What is desired is an improved methodology (utilizing a DSO, for example) for detecting and possibly removing aliased information when displaying FFTs.

### BRIEF SUMMARY OF INVENTION

Accordingly the present invention provides a method of alias detection when displaying FFTs. Specifically in one embodiment a method is provided of acquiring a signal under test (SUT) at each of a first sample rate and a second sample rate to provide respective first and second streams of samples, processing the first and second streams of samples according to a first function to determine respective spectral energy distributions, and comparing the spectral energy distributions to determine at least one spectral region including spectral energy common to each of the spectral energy distributions.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 depicts a high level block diagram of a signal analysis system.

FIG. 2 depicts an FFT of a first signal and a second signal resulting from a sample rate of 8 MS/s.

FIG. 3 depicts an FFT of the first signal and the second signal resulting from a sample rate of 9 MS/s.

FIG. 4 depicts an FFT of the first signal and the second signal resulting from a sample rate of 10 MS/s.

### DETAILED DESCRIPTION OF THE INVENTION

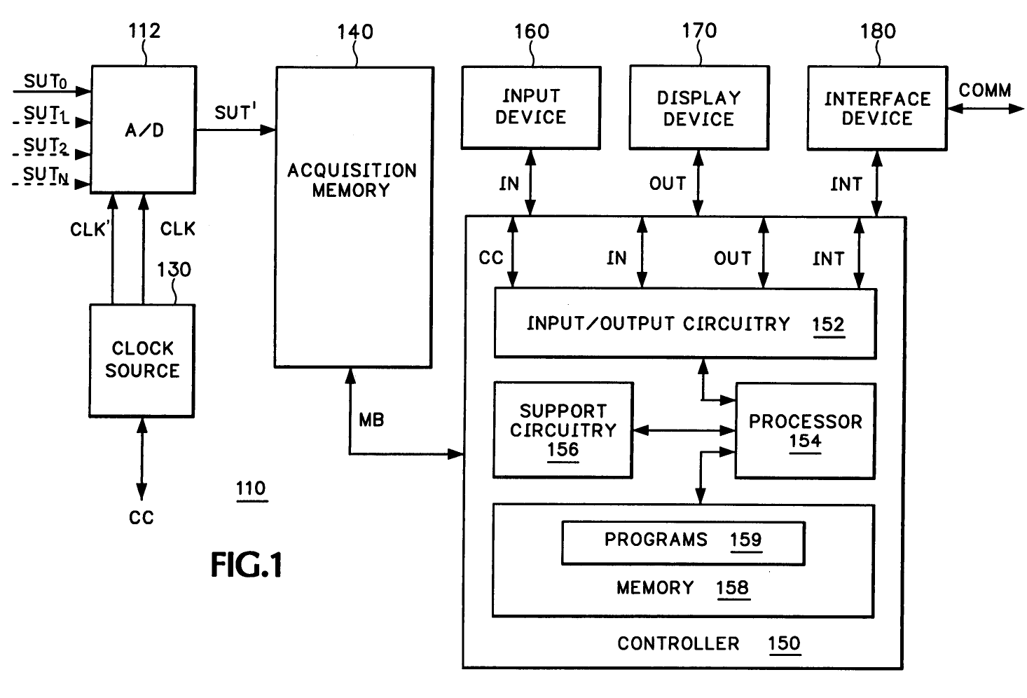

Referring now to FIG. 1 a high level block diagram of a signal analysis device is shown. Specifically, the system (signal analysis device) 110 has an analog to digital (A/D) converter 112, a clock source 130, an acquisition memory 140, a controller 150, an input device 160, a display device 170 and an interface device 180.

The A/D converter 112, which may be one or more A/D converters, receives and digitizes one or more SUTs (as shown by dotted lines for a multiple input device) in response to a clock signal CLK, or separate clock signals CLK′ for multiple A/D converters, produced by the clock source 130. The clock signal CLK generally is a clock signal adapted to cause the A/D converter 112 to operate at a maximum sampling rate, though other sampling rates may be selected. The clock source 130 may be responsive to a clock control signal CC produced by the controller 150 to change frequency and/or pulse width parameters associated with the clock signals CLK, CLK′.

A digitized output signal SUT′ produced by the A/D converter 112, which may be a concatenation of multiple input signals, is stored in the acquisition memory 140. The acquisition memory 140 cooperates with the controller 150 to store the data samples provided by the A/D converter(s) 112 in a controlled manner such that the samples from the A/D converter(s) may be provided to the controller for further processing and/or analysis.

The controller 150 is used to manage the various operations of the system 110. The controller 150 performs various processing and analysis operations on the data samples stored within the acquisition memory 140. The controller 150 receives user commands via an input device 160, illustratively a keypad or pointing device. The controller 150 provides image-related data to a display device 170, illustratively a cathode ray tube (CRT), liquid crystal display (LCD) or other display device. The controller 150 optionally communicates with a communications link COMM, such as a general purpose interface bus (GPIB), Internet protocol (IP), Ethernet or other communications link via the interface device 180. It is noted that the interface device 180 is selected according to the particular communications network used. An embodiment of the controller 150 is described in more detail below.

The system 110 is depicted as receiving one SUT input or multiple SUT inputs, where one SUT may provide multiple inputs or multiple SUTs may provide the multiple inputs, at the input of the A/D converter 112. Each SUT input from multiple SUTs or from multiple inputs of the same SUT is preferably processed using respective A/D converters 112, which A/D converters may be clocked using the clock signal CLK provided by the clock source 130 or by different clock signals CLK′ generated by the clock source or by multiple clock sources. Each of the additional digitized SUT inputs is coupled to the acquisition memory 140 or additional acquisition memory (not shown). Any additional acquisition memory communicates with the controller 150, either directly or indirectly through an additional processing element.

The controller 150 comprises a processor 154 as well as memory 158 for storing various control programs 159. The processor 154 cooperates with conventional support circuitry 156 such as power supplies, clock circuits, cache memory and the like, as well as circuits that assist in executing the software routines stored in the memory 158. As such, it is contemplated that some of the process steps discussed herein as software processes may be implemented within hardware, for example as circuitry that cooperates with the processor 154 to perform various steps. The controller 150 also contains input/output (I/O) circuitry 152 that forms an interface between the various functional elements communicating with the controller 150. For example, the controller 150 optionally communicates with the clock source 130 (via clock control signal CC). The controller 150 also communicates with the input device 160 via a signal path IN, a display device 170 via a signal path OUT and the interface device 180 via a signal path INT and the acquisition memory 140 via signal path MB. The controller 150 may also communicate with additional functional elements (not shown), such as those described herein as relating to additional channels, SUT processing circuitry, switches, decimators and the like. It is noted that the memory 158 of the controller 150 may be included within the acquisition memory 140, that the acquisition memory may be included within the memory of the controller, or that a shared memory arrangement may be provided.

Although the controller 150 is depicted as a general purpose computer that is programmed to perform various control functions in accordance with the present invention, the invention can be implemented in hardware as, for example, an application specific integrated circuit (ASIC). As such, the process steps described herein are intended to be broadly interpreted as being equivalently performed by software, hardware or a combination thereof.

It is noteworthy that the greatest frequency that can be put into a sampler without aliasing is ½ of the sample frequency (sample rate), or the Nyquist frequency. The Nyquist theorem, known in the art, states that a signal must be sampled at a minimum rate equal to twice the input signal frequency for accurate representation. Signals sampled at a rate lower than this minimum (the Nyquist Rate) is displayed as low-frequency signals due to insufficient sample points. Such a signal is called an aliased signal. The phenomenon is referred to as aliasing.

One embodiment according to the present invention involves detecting and optionally removing aliased signals displayed in the frequency domain with an FFT. Detecting and optionally removing aliased signals is especially useful when presenting frequency domain information to users.

In the frequency domain a signal component above the Nyquist frequency is displayed between DC and the Nyquist frequency. The frequency at which an aliased component is displayed depends on the Nyquist frequency. Signal components that are not aliased are displayed at their correct frequency and do not depend on the Nyquist frequency.

It is noteworthy that many signals that are observed in the frequency domain are repetitive or nearly repetitive. In such a case the system 110 acquires the signal multiple times in sequence and the frequency domain display from each acquisition is similar.

In one embodiment according to the present invention, as discussed herein, the system 110 varies the sampling rate on multiple acquisitions causing the Nyquist frequency to change. Frequency components that are not aliased continue to be displayed at the same frequency. However, frequency components that are aliased change their displayed frequency. In one embodiment, the user viewing corresponding waveform imagery detects the aliased components because they move around, blink or are displayed with less intensity than components that are not aliased. In another embodiment, the system 110 removes signal components that move around when the Nyquist frequency is changed using well known techniques.

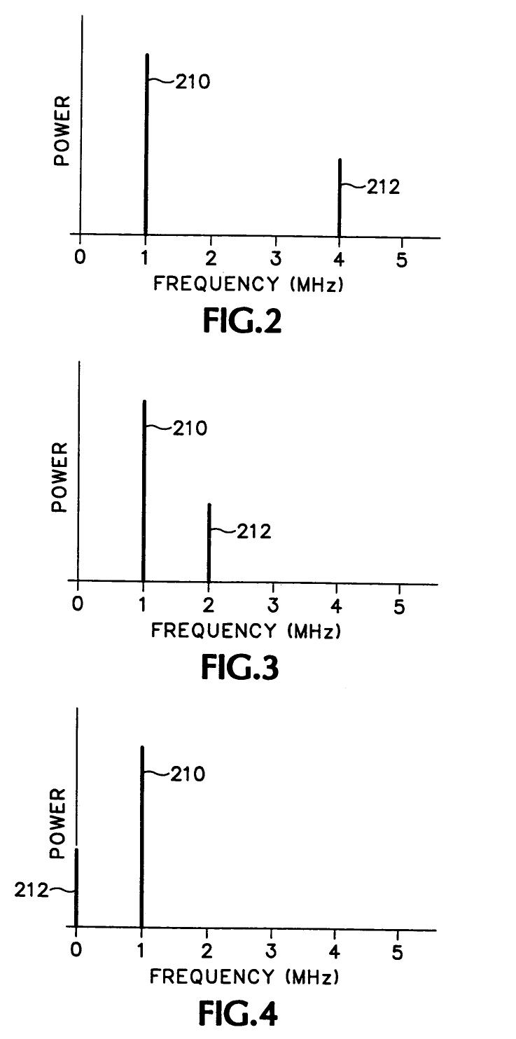

FIG. 2 depicts an FFT (or spectrum) of a first signal 210 and a second signal 212. The system 110 sets the sample rate to be 8 Mega samples (MS) per second (s) and the Nyquist frequency is thus 4 MegaHertz (MHz). The first signal 210 is not aliased and the second signal 212 is aliased. The frequency of the first signal 210 is 1 MHz and the frequency of the second signal 212 is 20 MHz. The first signal 210 is stronger than the second signal 212 as indicated by the height of the spikes. In one embodiment, the vertical axis generally represents signal amplitude and typically represents the 20 log of the signal voltage or 10 log of the signal power.

The system 110 displays the first signal 210 at 1 MHz because the first signal 210 is not aliased. The system 110 displays the second signal 212 at 4 MHz because the second signal 212 is aliased. It is noteworthy that one can determine where the aliased signal will be displayed by determining the magnitude of the difference frequency between itself and the nearest harmonic of the sampling frequency, i.e., the magnitude of the difference of the frequency of the aliased signal (20 MHz) and the second harmonic of the sampling frequency (16 Ms/s) is 4 MHz.

FIG. 3 depicts an FFT of the first signal 210 and the second signal 212. The system 110 changes the sample rate to 9 MS/s. A user can facilitate this change or it can be automatic. The Nyquist frequency is 4.5 MHz. Again, the first signal 210 is not aliased and the second signal 212 is aliased. The frequency of the first signal 210 is still 1 MHz and the frequency of the second signal 212 is still 20 MHz. The first signal 210 is still stronger than the second signal 212 as indicated by the height of the spikes.

The system 110 displays the first signal 210 at 1 MHz because the first signal is not aliased. The system 110 displays the second signal 212 at 20−2*9=2 MHz because the second signal is aliased.

FIG. 4 depicts an FFT of the first signal 210 and the second signal 212. The system 110 changes the sample rate to 10 MS/s. The Nyquist frequency is 5 MHz. Again, the first signal 210 is not aliased and the second signal 212 is aliased. The frequency of the first signal 210 is still 1 MHz and the frequency of the second signal 212 is still 20 MHz. The first signal 210 is still stronger than the second signal 212 as indicated by the height of the spikes.

The system 110 displays the first signal 210 at 1 MHz because the first signal is not aliased. The system 110 displays the second signal 212 at 20−2*10=zero MHz because the second signal is aliased.

In the case of a varying spectrum signal the respective FIGS. 2-4 may represent a single acquisition of the SUT sampled simultaneously at the different sample rates. The results are the same in that whatever frequency component is within the Nyquist band during the single acquisition appears to be steady in the several views, while aliased signals appear in different locations in the different views.

The full frequency spectrum from zero MHz to Nyquist has been shown for illustrative purposes. However, in a typical case the user may view a display that does not encompass the full frequency spectrum. For example, if the user was interested in the region around 1 MHz the user might set the display to show only the spectrum from zero MHz to 2 MHz. The display shows the 1 MHz signal at a constant position. A 20 MHz signal is displayed at different positions for different sample rates and thus different Nyquist values. The 20 MHz signal might alias inside or outside of the region being displayed, depending upon the sample rate. A dotted line, different color or the like may be used to represent a spike that is only present some of the time.

It is noteworthy that, when acquiring alternately, it is generally not possible to determine the difference between an aliased signal, which appears to be moving in frequency, and an SUT that is moving in frequency. As indicated above, however, when the SUT is moving in frequency it may be processed simultaneously at difference sample rates in a single acquisition to differentiate frequency components within the Nyquist band from aliased frequency components.

In use, the system 110 acquires (alternately or simultaneously) an SUT at each of a plurality of sample rates, such as at a minimum a first sample rate and a second sample rate, in order to provide respective streams of samples. The system 110 processes the streams of samples according to a first function (e.g., a Fourier transform including an FFT, a wavelet function, a discrete Fourier transform (DFT) or any other suitable function) to determine respective spectral energy distributions. The user (or a processor) then compares the spectral energy distributions in order to determine at least one spectral region that includes spectral energy common to each of the spectral energy distributions. The user (or a processor) then determines which signal(s) are aliased.

In one embodiment, the system 110 processes the spectral energy distributions associated with each of the corresponding spectral regions to attenuate non-common spectral energy components. This attenuation processing may be carried out in various ways as is well known in the art, such as, for example, by using a smoothing function, a minimizing function or any other suitable function.

In another embodiment, a method of determining real components of a signal and aliased components of a signal is provided. A large number of spectrums are created. The various spectrums are the result of acquiring the signal with different A/D clock frequencies. The spectrums are then re-sampled to align the individual frequency bins and summed together. The non-aliased frequencies then add and the aliased frequencies average down to a substantially lower level.

To make one kind of clean (non-aliased) display the first step is to acquire the signal at more than one sample rate. A spectrum for each acquired signal is produced. The spectrums are then re-sampled to align individual frequency bins. The process of re-sampling is usually performed in order to make a picture on a display device such as an LCD or a CRT. Those frequencies bins below a specified threshold are not displayed, while those above the specified threshold are displayed, i.e., the non-aliased frequencies are displayed while the aliased frequencies are eliminated from the display.

The surface of display devices are divided into pixels and the resolution of the pixels usually is different than the resolution of the spectrum. Schemes for displaying a plot exhibiting one resolution on a display device exhibiting a different resolution are known in the art.

The process that converts a plot into pixels on a screen may draw vertical line segments in each pixel column. Other schemes are possible, like a vector or line display of the frequency bin values. The minimum and maximum value for each bin may be displayed to show the signal variability, or an average value may be displayed if desired.

By performing this operation using a few spectrums, a set of minimum and maximum values for a column is obtained. The goal is to display the non-aliased components or, at least, make non-aliased components look different than potentially aliased components.

After obtaining the minimum and maximum values for each column, the average of the minimum and maximum for each spectrum in a column is examined. The minimum and maximum are retained for displaying.

For a column the data is placed in sorted order, from smallest to largest. Then, the middle value is selected to select the vertical line that will be displayed. For example, let us assume that we have acquired five waveforms at different sample rates. From these five waveforms spectrums have been found and re-sampled (perhaps to line them up with pixels for display). The preceding methodology is then repeated for remaining columns.

Subsequently, the system draws a waveform using the center-most line segments that were selected. The final plot is comprised of pieces of five plots in this embodiment. In order to identify an aliased frequency component, simply locate a line segment that is much taller than the others.

In one embodiment, the user can change various parameters of the system 110. Examples of these parameters include sample rate, record length, frequency band, frequency resolution, center frequency selection, update rate and any other suitable parameters.

The system 110 can display for the user spectral energy regions of spectral energy distributions having common spectral energy components. The system 110 can display spectral energy regions of spectral energy distributions having common spectral energy components in one color and spectral energy regions of spectral energy distributions having non-common spectral energy components in another color, intensity level or the like. As one example one acquisition of the SUT may be displayed in one color and another acquisition of the SUT may be displayed in another color and overlaid with the first acquisition so that the common frequency components appear in a third color, which is a combination of the first two colors.

Other types of identifiers can be used as well (e.g., icons, pointers, textual identifiers or the like). These identifiers can be placed proximate to the appropriate regions. Spectral energy regions of the respective spectral energy distributions having common or non-common spectral energy components can be presented in various ways, such as with different brightness or intensity levels, etc. It is envisioned that any suitable number of different sample rates can be used according to embodiments of the present invention.

While the foregoing is directed to the preferred embodiment of the present invention, other and further embodiments of the invention may be devised without departing from the basic scope thereof, and the scope thereof is determined by the claims that follow.

1. A method, comprising:
acquiring a signal under test (SUT) at each of at least two sample rates to provide thereby respective streams of samples;
processing the respective streams of samples according to a first function to determine thereby respective spectral energy distributions; and
comparing the respective spectral energy distributions to determine a spectral region including spectral energy common to each.

2. The method of claim 1 wherein the SUT is alternately acquired at each of the sample rates.

3. The method of claim 1 wherein the SUT is simultaneously acquired at each of the sample rates.

4. The method of claim 1 wherein the comparing step comprises the step of processing the respective spectral energy distributions associated with each of a plurality of corresponding spectral regions to attenuate non-common spectral energy components.

5. The method of claim 4 wherein respective spectral energy distributions processing step comprises the step of using at least one of a smoothing function and a minimizing function.

6. The method of claim 1 further comprising the step of presenting on a display device the spectral region of the respective spectral energy distributions having common spectral energy components.

7. The method of claim 6 wherein the common spectral energy components of the spectral region are presented in one color and non-common spectral energy components are presented in another color.

8. The method of claim 6 wherein the common spectral energy components of the spectral region are presented in one intensity level and non-common spectral energy components are presented in another intensity level.

9. The method of claim 1 wherein the comparing step comprises the step of comparing at least two of the respective spectral energy distributions when there are more than two sample rates to determine thereby the spectral region common to each of the at least two respective spectral energy distributions.

10. The method of claim 1 wherein the first function comprises a function selected from the group of functions consisting of at least a Fast Fourier transform (FFT) function, a wavelet function, a chirp function and a discrete Fourier transform (DFT).

11. The method of claim 1 wherein the sample rates are selected to cause aliased signal spectral energy to be distributed in a spectrally non-common manner.

12. The method of claim 1 further comprising the step of adapting the sample rates in response to user interaction, the user interaction including at least one of a sample rate selection input, a record length selection input, a frequency band selection input, a frequency resolution input, a center frequency selection input and an update rate.

13. An apparatus comprising:
an input channel for acquiring a signal under test (SUT) at a plurality of sample rates to provide thereby respective streams of samples; and
a processor for processing the respective streams of samples according to a first function to determine thereby respective spectral energy distributions, and for comparing the spectral energy distributions to determine thereby a spectral region including spectral energy common to each of the respective spectral energy distributions.

14. The apparatus of claim 13 wherein the SUT is alternately acquired at each sample rate.

15. The apparatus of claim 13 wherein the SUT is simultaneously acquired at each sample rate.

16. The apparatus of claim 13 further comprising a display processor for generating an output signal for presentation on a display device an image representative of the spectral region of the respective spectral energy distributions having common spectral energy components.

17. The apparatus of claim 16 wherein the common spectral energy components are presented in one color and non-common spectral energy components are presented in another color.

18. The apparatus of claim 16 wherein the common spectral energy components are presented in one intensity level and non-common spectral energy components are presented in another intensity level.

19. The apparatus of claim 16 wherein spectral energy from each acquisition of the SUT is displayed in a different color, and wherein common areas of spectral energy are visible in yet another color.
